(19) United States
(12) Patent Application Publication
(10) Pub. No.: US 2002/0175918 A1
(43) Pub. Date: Nov. 28, 2002

(54) Method and system for implementing a path network in a computer graphics scene

(76) Inventor: John S. Barber, Cary, NC (US)

Correspondence Address: HAYNES AND BOONE, LLP, 901 MAIN STREET, SUITE 3100, DALLAS, TX, 75202, US

(21) Appl. No.: 09/836,621

(22) Filed: Apr. 17, 2001

(51) Int. Cl. G06T 13/00

(52) U.S. Cl. 345/474

(57) ABSTRACT

A method is provided for implementing a path network for controlling motion behaviors of at least one object in a computer graphics scene. The path network is formed by a plurality of nodes and segments. Various parameters affiliated with the nodes or the segments are defined for establishing motion conditions for the object to travel along the path network.

### BACKGROUND OF THE INVENTION

The present invention relates generally to computer graphics display systems, and more particularly, to a method and system for dynamically implementing path networks in a computer graphics scene.

A computer graphics scene closely depicts a three dimensional (3D) world by using computer graphics processing technologies. A typical computer graphics processing system is used to represent two-dimensional or three-dimensional objects in the graphics scene and render them for display on a two-dimensional display device. The computer graphics processing system normally includes computers, display devices, input devices, and other necessary hardware and software for processing and displaying computer graphics.

The scenes displayed on such a system are designed by a graphics designer, who uses special-purpose software to design and place characters and objects within the computer graphics scene. Once designed, the scene is later animated or run under the control of users, who use one or more input devices to interact with a computer graphics processing system under their control (e.g., by entering commands to affect the placement and movement of objects and characters within the scene).

During some graphics animation processes, computer users can, under certain circumstances, modify the apparent movements of the objects or characters in the graphics scene. With the assistance of appropriate software programs and input devices such as a mouse, a keyboard, a joystick, voice commands, touch panels or control areas, a user asserts great control over the dynamic appearance of the graphics scene. In some cases, the user can alter the display of the scene, change the position or movement of displayed objects or characters, or move the apparent point of view (the “camera”) of the entire scene. The computer graphics scene may be animated, either by movement of the objects within the scene, or by moving the camera, to give an appearance that an observer is moving within the scene. During the animation, images or “frames”, are created and displayed in rapid succession, typically 30 or more frames per second. Also defined in the software program is the logic or algorithms for displaying and animating the scene. The motions of the objects as defined by the software programs within the scene may include changes to the position, orientation, speed, acceleration, or movement of displayed objects or characters.

In order to improve the quality of the computer graphics animation, motion control has become a major issue. Sophisticated animation applications will usually have more options for controlling motions of the objects contained in the scene. In the current art, several forms of motion are implemented in scene editing and playback software. Such scene editing and playback software usually includes one or more of the following motion controlling features:

Simple motion: an object moves at a preset speed in a preset direction or pattern. For example, an object is instructed to move along a predetermined coordinate axis at a pre-selected speed or to spin around the axis.

Static Path: an object only moves along a predefined path.

Motion File: an object's parts move relative to a base point of the object in accordance with a previously captured motion file. It is typically a short, and repeated function. For instance, for depicting a simulated human body (“avatar”) in a walking motion, the avatar's motion to take a single step can be repeated in multiple times to make it appear as if it is walking continuously.

Algorithmic Motion: an object moves based on a predetermined algorithm. For example, the object moves in a circle or accelerates at a certain rate as it moves.

Relational Motion: an object moves in relation to one or more other objects. For example, the motion of a piston rod in the graphics scene is correlated to that of a spinning crankshaft.

User Controlled Motion: random navigation through the scene under the control of the user by using a control device such as a mouse, keyboard or joystick, etc.

The above-mentioned motion control features still do not provide enough freedom to control the motions of the objects. For example, in computer games where the user has to navigate through a complex set of rooms or hallways, typical free-form navigation techniques rely on the users having good fine motion control and a lot of experience using the navigation control device (mouse, keypad, joystick) to go where they want. This is difficult for novice users and can result in bumping in to walls, or getting stuck in inappropriate locations that don't advance the game.

What is needed is an efficient method and system for providing logical movements of the objects in computer graphics scenes.

### SUMMARY OF THE INVENTION

A method is provided for implementing a path network for controlling motion behaviors of at least one object in a computer graphics scene. In general, path networks are compatible with any other existing forms of motion control mechanisms in 3D computer graphics technologies. In one embodiment, the path network is formed by a plurality of nodes and segments. Various parameters affiliated with the nodes or segments are defined for establishing motion conditions for the object to travel along the network setup by the segments and the nodes. Objects in the 3D scene are capable of being instructed to navigate through the network, or go from node to node along the defined segments between the nodes. The motion conditions include motion speed for the object to travel on the path network, turning smoothness, orientation of the object, wait time at each node, and reorient time for each segment. Moreover, the path network may have a plurality of operation modes.

In another example of the present invention, a method is disclosed for using at least one embedded path network for providing motion guidance to at least one object in a computer graphics scene. The embedded path network is first established by setting up a plurality of nodes and segments. For example, the locations of the nodes, the travel direction of each segment, and a plurality of entry points to the path network are determined. When the object is close to the path network, it is directed to the established path network.

Once on the path network, the object is able to move under the control of the path network, depending on a plurality of predetermined attributes associated with the nodes and segments of the path network. The attributes may include, among others, turning smoothness, orientation of the object, wait time at each node, and reorient time for each segment. At a certain node or segment, the object may be instructed to make a random selection from available segments to travel thereon. The object may also be instructed to make a selection of an available segment to travel thereon at each node based on a probability assigned to the available segment. The object may also be instructed to go to a predetermined node which is a travel destination for it. While the object travels through the path network, in order to update a motion status of the object, one or more control messages are sent when the object reaches a predetermined node. Despite various controls imposed by the path network, a user is still permitted to control the motion of the object manually.

### BRIEF DESCRIPTION OF THE DRAWINGS

FIG. 1 illustrates a sample path network according to one example of the present invention.

FIG. 2 illustrates a computer system for implementing the present invention.

### DESCRIPTION OF THE PREFERRED EMBODIMENT

The present invention provides a framework for controlling complex motions of various objects in a three-dimensional (3D) graphics scene. This framework is generally referred to as a “path network,” and it is understood that a graphics scene can have a large overall path network as well as many localized path networks.

There are three general procedural steps for implementing the path network. First, during the design of the graphics scene, the graphics designer identifies or creates nodes of the path network and assigns them with various characteristic attributes. Second, scripts are defined. The scripts define motions along the path network for objects within the scene are provided. Third, the objects in the scene carry out the preplanned or user-influenced motion along the path network during animation of the scene.

Establishing Path Networks

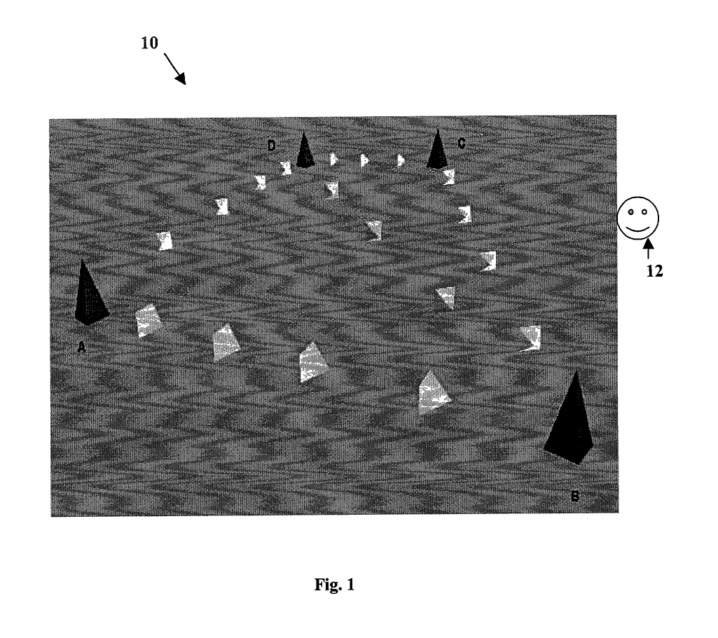

Referring to FIG. 1, a sample path network 10 is shown as it may exist in a computer graphics scene. In this simple graphics scene, four nodes are defined and labeled as “A,” “B,” “C,” and “D.” Further, the path between any two nodes is considered to be a segment and identified by the two end nodes. In a computer program defining such a path network, the nodes can be arranged in the form of a linear hierarchical list. Nodes of the path networks in a computer graphics scene under development are identified or created by graphics designers.

Each of the nodes A-D of the path network 10 is illustrated as a pyramid with its peak point indicating which direction the object should travel. The graphics designer decides whether the path network nodes are visible in the display.

Path segments such as segments AB, CB, DC, AD, and DB are illustrated with small directional objects such as the hedras (double ended pyramid) as shown for bidirectional segments such as the segments AD, DC and CB or small pyramids pointing in the direction of a unidirectional path segment such as segments AB and DB. The unidirectional path indicates that an object moving on this path can only travel one way in the indicated direction. There is no defined segment between the other two diagonally opposed path network nodes, i.e., AC.

The designer creates the path network 10 by locating and defining the nodes of the network using one or more of the following:

1. Place a node at the current camera location

2. Place a node at the location of an existing object within the scene

3. Place a node at the current cursor location with the scene

4. Place a node at a specific coordinate location within the scene

5. Place a node relative to a reference such as the camera, an object, the cursor, or coordinate, or previously located node.

Various techniques for locating and placing a node can be used. Conventional interactive methods such as drag and drop, pop-up menus, data entry dialog panels, main menu and sub-menu item selection, and others can all be used. The node can also be added by activating one or more predetermined keys. In addition, a specially designed interactive option box such as a “Create Path Network Node” option graphic user interface box. A node can also be created via scripted message at a specified location through an application program interface (API). The nodes are named, and can be renamed. Node names are used as references in the network.

Each node or segment is associated with one or more characteristic attributes. The characteristics represented by these attributes would include definitions or limitations of directionality, speed, and orientation rules. With these attributes, scripting or direct user interactions would then be able to direct one or more objects in the graphics scene to follow a path network with some motion guidance. Reasonable default values would be assigned to the attributes of each node or segment in the path network. In one example of the present invention, the attributes may include:

Names of each node;

Object Turn Rates at each node (in degrees per second);

Object Speed for each segment (speed in units per second);

Weighting (probability factor) indicating how likely a node should be taken (a number between 0 and 1) in the path;

Directionality of each segment (either directional or bi-directional);

Default orientation for the object;

Reorient Time for each segment (e.g. fixed number of seconds or random number between predetermined bounds); and

Wait Time at each node (e.g. fixed number of seconds or random number between predetermined bounds).

In the present embodiment, the designer has absolute control of these attributes. For instance, the designer could override these default values at design time or subsequently via scripted messages during editing. An edit mode for the path network would also allow previously specified node and segment information to be altered.

When placing a new node into the existing path network, the designer links the new node to one or more other nodes to establish a relation among them so as to broaden the network. This “linking” function enables the designer to set attributes defining the behavior of the objects at or around each node or path segment of the path network. The linking process would be done either graphically in the scene itself, or manually in the edit dialogs associated with the path network. For example, graphically, the user would select an existing node and choose a “LinkTo” option (provided by an applicable software) before selecting other nodes to be linked. Alternatively, the designer would invoke a “choose option” that would define desired linkages by selecting entries in an predetermined array or by typing the names of the nodes need to be linked.

The nodes and segments are the basic elements of the path network, and various control features are node/segment based. The information about the nodes and segments is stored in arrays within the program defining the scene. The arrays containing information about all the nodes and segments of a path network for identifying them, and the parameters related to them. It would need to identify information about all the paths that an object may need to go from one node to any other node in the path network, including, although by no means exhaustive, whether a segment exists, speed for the segment, default orientation for an object on that segment, and turn smoothness information.

For illustration purposes, the path network shown in FIG. 1 corresponds to three arrays below, one defining the nodes alone, one for the segments, and another for the different paths. The overall name for the path network can be Example_Path_Network in this case, and it identifies the following three arrays:

Path Nodes Array:

| | | | | Turn | |
|---|---|---|---|---|---|
| Name | x | y | z | Condition | Wait Time |
| A | 123 | 0 | 50 | 0.5 | 0 |
| B | 300 | 18 | 55 | 0.9 | 1 |
| C | 339 | 400 | 63 | 0.0 | 0.5 |
| D | 102 | 380 | 58 | 1.0 | 2 |

Segment Array:

| | | | Default | Reorient | |
|---|---|---|---|---|---|
| Segment | Speed | Distance | Orientation | Times | Weighting |
| AB | 5 | 189 | Ahead | 5 | 0.5 |
| BC | 8 | 420 | As Previous | 4 | 1.0 |
| CB | 8 | 420 | Ahead | 0 | 0.2 |
| CD | 5 | 250 | Ahead | 4 | 0.8 |
| DC | 5 | 250 | Ahead | 1 | 0.4 |
| DA | 3 | 370 | Target | 0 | 0.6 |
| AD | 6 | 370 | Target | 0 | 0.5 |
| DB | 8 | 490 | Ahead | 3 | 0.0 |

Paths Array:

| From | | | | | | |
|---|---|---|---|---|---|---|
| Node | Path | Path | Path | Path | Path | Path |
| A: | AB | ABC | ABCD | AD | ADC | ADB |
| B: | BC | BCD | BCDA | | | |
| C: | CB | CD | CDB | CDA | CDAB | |
| D: | DC | DCB | DB | DA | DAB | DABC |

Under normal circumstances, there are two functional modes for implementing the path network, a play mode and an edit mode. In the edit mode, the designer actually edits the graphics scene using the path network. In the play mode, the scene is played by a user with the defined path networks in place. The designer has absolute control over whether the nodes and segments would be displayed. The nodes and segments may be displayed during both edit and play modes, displayed only during edit mode, or not displayed in edit or play mode.

In the edit mode, the designer can dynamically generate and insert small objects such as the hedras, or single pyramids as shown in FIG. 1 for graphically showing a permitted direction of the path segment. Colors can also be used to differentiate different segments formed by the pyramids. The number of the objects generated between the nodes to represent the segments can also be dynamically imposed based on the distance between two predetermined nodes. As a general rule, the shorter the segment the fewer the objects.

In the edit mode, other mechanisms also provide several ways to view and alter the definition of a path network. For example, the entire path network can be selected and dragged to a new location or dragged to alter its orientation. The coordinates and orientation of the entire path network can be altered directly using a user control interface when the entire path network is selected. Each node can be selected and dragged to a new location. The coordinates and orientation of an individual node can also be altered directly by entering the exact coordinates when the node is selected. Other properties such as segment speeds, turn rates, and node connectivity can also be manipulated. Other control and management schemes can be implemented as well. For example, right clicking on any node or segment would bring up a dialog box defining the parameters related to that node or segment, and would offer an opportunity to delete that node or segment.

When a path network is defined or edited, the distance between any two nodes in the path network is calculated automatically and stored with other information defining the path network. Using that distance information, the path network can quickly calculate the appropriate path from any point in the network to any other point in the network subject to the graphics designer's control.

Defining Scripts

The movement of objects in the path network of the computer graphics scene can be controlled manually, wherein an input device, such as the keyboard or mouse, controls the speed and paths for the object to travel. For example, if an object is approaching a junction or node where multiple paths are possible, then holding down a right arrow as the object passes that node would encourage it to choose a predetermined path in the path network that this node is in. The speed of the object might also be controlled manually, by overriding or altering the segment speeds defined in the path network.

In this stage, the designer can also construct one or more scripts utilizing the defined path network which function as a guide for movements of the objects along various paths within the path network. In one example of the present invention, each path may be described in a Random, Weighted, or GoToNode mode.

If the path network is in the Random mode, an object would move to a predetermined place in the path network and then determine its next path through the path network by making a random selection from available paths or segments. This mode is useful, for example, for objects running continuously in the scenes.

If the path network is in the Weighted mode, after the object moves to a predetermined place in the path network, it would then determine its movement direction based on the rules specified at each node. These rules indicate allowable paths at the node and a probability for taking each path.

If the path network is in the GoToNode mode, the object at a node would be directed to a target node through some predetermined nodes and path segments as defined by the rules at the node. As to which path should be chosen to get to the target node, it is determined based on parameters supplied by the scene designer, the user, or the user's actions. Sample choices could include a fastest route, shortest route, random route, or weighted route. In one example, several steps may be involved. For instance, an object first gets to a predetermined path network node that is closest to its current location. Using information stored at the node about its connectivity and distances to other modes, a best path is determined to get to a target node. The object can move perpendicularly to a first segment of the determined best path, and then follow the best path to the target node, obeying all the speed and orientation rules defined in the path network.

The “GoToNode” mode is particularly useful where some key nodes in the path network must be visited by the user while at the same time the object is granted with the freedom to “tour around” a scene.

Common to all modes of the path network, there are two basic parameters to an entry point of the path network, EntryPoint and EntrySpeed. An EntryPoint would either be a specified path network node or other predefined point on the path network. The EntrySpeed would define the speed with which the object would move to the EntryPoint. Similarly, the nodes and some other points can be assigned as exit points where the object can get off the path network. The EntryPoints can be the exit points too. Various motion controls available at the entry points can be applied to the exit points as well. It is understood that various control algorithms can be implemented to direct an object to get on or off the path network. For example, the designer can determine a particular EntryPoint to be the only entry point when an object enters a certain area close to the EntryPoint. Alternatively, the object may get to or get off from a predetermined entry point only if certain conditions are fulfilled. The path network lend a great deal of freedom to the designer to decide how the entry/exit points are planned.

Once the object gets on the path network, its initial direction of travel is dependent on the information provided at the EntryPoint.

The object following the instruction from the path network may change its movement based on some specific overriding orientation messages imposed by the path network. Orientation time determines how long in seconds an orientation change would take place.

Various control messages may be invoked at certain points in the path network when an object is traveling through to update a motion status of the object. For example, upon arriving at each node of a path network, a message may be sent indicating that the object has reached that node in that path network. Upon arrival at a target node, a message will be issued indicating that the object has reached the specified target.

When the object needs to turn at a certain node, the smoothness of the turn will be dynamically defined based on the scene designer's preference that applies to the whole path network or any particular segment of the network. A smoothing control can be imposed. For instance, the preference will be specified as a value between 0 and 1, where 0 represents no turn smoothing and 1 represents maximum turn smoothing. In effect, the actual path of the object as it goes through a smoothed turn would not go directly through the node, but would rather “cut the corner” around the node.

Referring back to FIG. 1, assuming that an object 12 is located somewhere between and to the right of Nodes B and C, it is then instructed to use the path network to go to Node A. Using the array described above where information is stored about the path network, it would first determine that the closest segment to its current position is segment CB. It would then determine that there is only one logical way to Node A, i.e., by going first to C, then to D, then to A since unidirectional segments block any path through B to A. The move would then occur by having the object move perpendicularly to the CB segment, then when it intersects the CB segment, the object would move to C, then D, and finally, to A. The speed of the object travelling on the path segments and the smoothing control on turns are determined based on the parameters of those segments or nodes in the array.

In a more complex network it is possible to have several possible paths to a target node. Information about the distance for each segment is used to calculate the distances and speeds for all possible paths to A. Depending on what the scene designer or the user indicates, the path chosen to the target node can be one of the shortest, the fastest, or a random and a weighted legal path.

Graphics Animation

After the path networks are defined in the graphics scene, during the computer animations, the defined scripts are activated and the instructed motions are carried out by generating appropriate frames for display as the objects move along the path networks.

Exemplary System

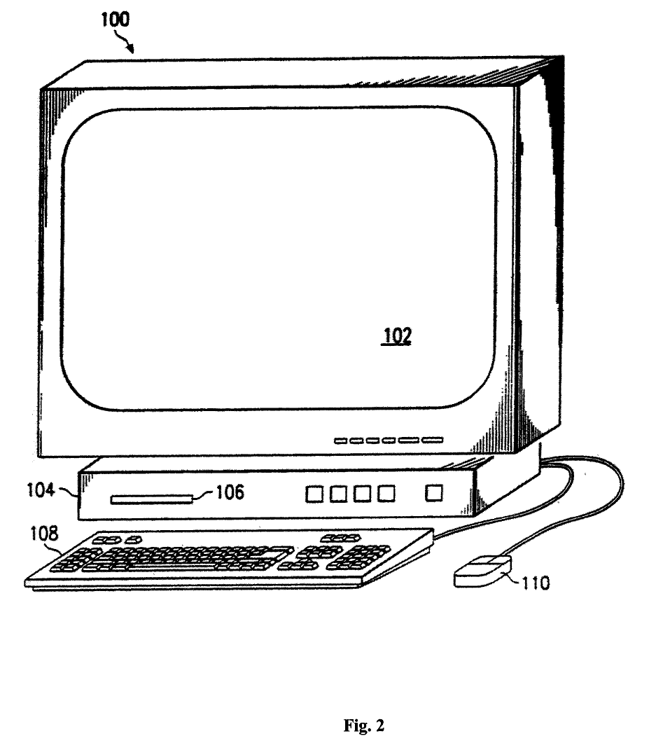

Referring now to FIG. 2, it will also be understood by those having skill in the art that one or more elements/steps of the present invention may be implemented using software executed on a general purpose computer system or networked computer systems, using special purpose hardware-based computer systems, or using combinations of special purpose hardware and software. For the sake of further illustrating the above examples, a typical computer system 100 for implementing embodiments of the present invention is shown which includes a two-dimensional graphical display (also referred to as a “screen”) 102 and a central processing unit 104. The central processing unit 104 contains a microprocessor and random access memory for storing programs. A disk drive 106 for loading programs may also be provided. A keyboard 108 having a plurality of keys thereon is connected to the central processing unit 104, and an input device such as a mouse 110 is also connected to the central processing unit 104.

Conclusion

In summary, the present invention provides a framework for implementing embedded path networks in a three-dimensional (3D) scene so that objects may be moved in logical ways as defined by the path networks. The path networks have a collection of nodes that are specified in a 3D scene. The nodes are connected by segments to define a path. Objects in the 3D scene are capable of being instructed to navigate through the network, going from node to node along the defined segments between the nodes. Parameters related to the nodes or the segments govern how the objects enter and navigate through the network. Path networks are compatible with any other forms of existing motion control in 3D computer graphics technologies. Combining the motion controls available under the path networks with other existing control mechanisms is possible.

The present invention has various advantages over conventional object motion controls in the computer graphics scene. Path networks provide significant new function and flexibility compared to these existing forms. For example, the present invention provides a solution to many “GoTo” problems for objects in a 3D scene. Path networks also provide a way to logically enter a path network even if the object to be moved isn't already on one of the path segments. Similarly, the path networks allow an object to move through the path network, and then to get off at destination point in the graphics scene.

Another advantage of the present invention is that it provides a way to simplify complex user controlled navigation. For example, in some complex scenes, navigation of the active camera becomes difficult for novice users to accurately control the motion within the bounds of the scene. For instance, manually navigating down complex corridors and turning corners accurately without bumping into walls can be challenging. The present invention solves this problem by allowing the user to influence the motion through input devices along with embedded controls from the path network thus eliminating the need of involving more complex and resource intensive collision detection logic. This is extremely useful for computer games in their novice user modes. Similarly, the 3D scenes enhanced by the path networks for kiosks used in the public would be able to provide directions and actual routes for the user to get to a desired destination.

The present invention also provides an easy approach to generate variations in an automated scene. For example, the random and weighted path options allow objects to be set in motion in a complex network of paths in such a way that a passive viewer would seldom see the same scene in a certain period of time. This is extremely useful in generating seemingly random scene tours that do not appear recognizably repetitious.

In practice, the present invention can be used in various applications. For example, path networks would provide flexible but constrained guided tours though 3D scenes depicting houses, apartments, theme parks, museums, campuses, or even entire cities. Using a combination of Manual mode or GoToNode mode, scene designers could give whatever amount of freedom as appropriate to end users. The end users could be allowed to explore only along predetermined path segments or they could be allowed to navigate at will around the scene, but reenter the path network at any time from any place in the scene.

Path networks are a natural framework for presenting virtual malls or shopping centers. Users would be able to wander about the mall as if they were “just shopping,” but could be taken directly to some virtual storefront in the mall at any time by initiating the GoToNode mode at any point in their experience. For example, virtual shopping crowds may be walking about the mall, buses and cars might drive around city streets in logical ways as the user navigates about the scene. These other objects add realism to the scene if they are made to behave in a realistic manner. Path networks allow the scene designer to easily implement such seemingly intelligent motion for any mode of scene.

The path networks can also be used in complex scenes in training manuals to give navigational freedom to users investigating the training scenes, but still restrict the user to reasonable paths through the scene. For example, a training manual for a printer would not have to provide a restricted set of views of the printer as it explained how to change ink cartridges, insert paper or clear paper jams. Instead, it could offer the user a chance to explore along reasonable paths of their choice as they learned the things they wanted to learn. The features of the path network would function more as an invited assistant to the learning experience than as a rigid controller of the training.

Further, automatic exhibits can be used in situations where multiple users might be viewing the scene and no user controls are desired for the navigation. The random or weighted modes of path networks can allow such exhibits to be non-repetitive and endlessly changing while keeping the camera moving along valid paths.

The above disclosure may provide many different embodiments, or examples, for implementing different features of the invention. Specific examples of components, and processes are described to help clarify the invention. These are, of course, merely examples and are not intended to limit the invention from that described in the claims.

While the invention has been particularly shown and described with reference to the preferred embodiment thereof, it will be understood by those skilled in the art that various changes in form and detail may be made therein without departing from the spirit and scope of the invention, as set forth in the following claims.

What is claimed is:

1. A method for implementing a path network for controlling motion behaviors of at least one object in a computer graphics scene, the method comprising:
providing one or more nodes for the path network, a connection between any two nodes defining a segment; and
defining one or more parameters affiliated with the nodes or the segments for establishing motion conditions for the object to travel along the path network.

2. The method of claim 1 wherein the step of providing further includes providing a graphical indication of a permitted traveling direction of the object.

3. The method of claim 1 wherein the step of providing further includes defining at least one entry point of the network.

4. The method of claim 1 wherein the motion conditions include:
motion speed for the object to travel on the path network;
turning smoothness;
orientation of the object;
wait time at each node;
reorient time for each segment; and
one or more operation modes.

5. The method of claim 4 wherein the operation modes further include manual mode, weighted mode, and gotonode mode.

6. A method for using at least one embedded path network for providing motion guidance to at least one object in a computer graphics scene, the method comprising:
establishing at least one embedded path network, the path network having a plurality of nodes and segments;
directing the object to the established path network; and
controlling the object to move along the path network depending on a plurality of predetermined attributes associated with the nodes and segments of the path network.

7. The method of claim 6 wherein the step of establishing further includes
determining locations of the nodes;
determining a travel direction of each segment; and
determining a plurality of entry points to the path network.

8. The method of claim 6 wherein the step of directing further includes determining a travel path to get on the path network.

9. The method of claim 6 wherein the attributes include turning smoothness, orientation of the object, wait time at each node, and reorient time for each segment.

10. The method of claim 6 wherein the step of controlling further includes instructing the object to make a random selection from available segments to travel thereon.

11. The method of claim 6 wherein the step of controlling further includes instructing the object to make a selection of an available segment to travel thereon at each node based on a probability assigned to the available segment.

12. The method of claim 6 wherein the step of controlling further includes instructing the object to go to a predetermined node.

13. The method of claim 6 wherein the step of controlling further includes sending one or more control messages when the object reaches a predetermined node updating a motion status of the object.

14. The method of claim 6 wherein the step of controlling further includes permitting a user to control the motion of the object in addition to the control imposed by the path network.

15. A computer program for using at least one embedded path network for providing motion guidance to at least one object in a computer graphics scene, the program comprising instructions for:
establishing at least one embedded path network, the path network having a plurality of nodes and segments;
directing the object to the established path network; and
controlling the object to move along the path network depending on a plurality of predetermined attributes associated with the nodes and segments of the path network.

16. The program of claim 15 wherein the step of establishing further includes:
determining locations of the nodes;
determining a travel direction of each segment; and
determining a plurality of entry points to the path network.

17. The program of claim 15 wherein the step of directing further includes determining a travel path to get on the path network.

18. The program of claim 15 wherein the attributes include turning smoothness, orientation of the object, wait time at each node, and reorient time for each segment.

19. The program of claim 15 wherein the step of controlling further includes instructing the object to make a random selection from available segments to travel thereon.

20. The program of claim 15 wherein the step of controlling further includes instructing the object to make a selection of an available segment to travel thereon at each node based on a probability assigned to the available segment.

21. The program of claim 15 wherein the step of controlling further includes instructing the object to go to a predetermined node.

22. The program of claim 15 wherein the step of controlling further includes sending one or more control messages when the object reaches a predetermined node updating a motion status of the object.

23. The program of claim 15 wherein the step of controlling further includes permitting a user to control the motion of the object in addition to the control imposed by the path network.

24. A method for using at least one embedded path network for providing motion guidance to at least one object in a computer graphics scene, the method comprising:
determining locations of one or more nodes of at least one embedded path network, the distance between any two nodes defining a segment;
determining a travel direction of each segment;
determining a plurality of entry points to the path network;
directing the object to the established path network through a predetermined travel path to get on the path network; and
controlling the object to move along the path network depending on a plurality of predetermined attributes associated with the nodes and segments of the path network, the attributes including turning smoothness, orientation of the object, wait time at each node, and reorient time for each segment.

25. The method of claim 24 wherein the step of controlling further includes instructing the object to make a random selection from available segments to travel thereon.

26. The method of claim 24 wherein the step of controlling further includes instructing the object to make a selection of an available segment to travel thereon at each node based on a probability assigned to the available segment.

27. The method of claim 24 wherein the step of controlling further includes instructing the object to go to a predetermined node.
